(19) United States
(12) Patent Application Publication
(10) Pub. No.: US 2007/0106716 A1
(43) Pub. Date: May 10, 2007

(54) Shared Classes Cache Computer System and Method Therefor

(76) Inventor: Benjamin John Corrie, London (GB)

Correspondence Address: IBM CORPORATION, 3039 CORNWALLIS RD., DEPT. T81 / B503, PO BOX 12195, REASEARCH TRIANGLE PARK, NC, 27709, US

(21) Appl. No.: 11/557,681

(22) Filed: Nov. 8, 2006

(30) Foreign Application Priority Data
Nov. 10, 2005 (GB) 0522939.8

(51) Int. Cl. G06F 17/30

(52) U.S. Cl. 707/206

(57) ABSTRACT

A JVM shared classes cache computer system (300) and method therefor (500) allowing efficient dynamic updates by referencing (120, 220) entries in the cache (400) and using an indication (460) of the staleness of an indexed entry, whereby a stale cached class can be identified. Each JVM has a local hash table (130, 230) containing a classpath entry's string name, and a circular linked list, each entry of which represents a classpath in the cache which contains an associated classpath entry, each item in the linked list comprising a pointer to a classpath in the cache, an index of that classpath entry in the classpath, and a pointer to the next item in the list (or itself if the list contains only one item). This provides an extremely efficient technique for marking shared cache classes as ‘stale’, allowing for dynamic updates.

### FIELD OF THE INVENTION

This invention relates to object-oriented programs in which cached classes are used.

### BACKGROUND OF THE INVENTION

It is known that programs written in the JAVA programming language (JAVA is a trademark of Sun Microsystems, Inc.) are generally run in a virtual machine environment, rather than directly on hardware. Thus a JAVA program is typically compiled into byte-code form, and then interpreted by a JAVA virtual machine (JVM) into hardware commands for the platform on which the JVM is executing. The JVM itself is an application running on the underlying operating system. An important advantage of this approach is that JAVA applications can run on a very wide range of platforms, providing of course that a JVM is available for each platform.

JAVA is an object-oriented language. Thus a JAVA program is formed from a set of class files having methods that represent sequences of instructions (somewhat akin to subroutines). A hierarchy of classes can be defined, with each class inheriting properties (including methods) from those classes which are above it in the hierarchy. For any given class in the hierarchy, its descendants (i.e., below it) are called subclasses, whilst its ancestors (i.e., above it) are called superclasses.

At run-time classes are loaded into the JVM by one or more class loaders, which themselves are organised into a hierarchy. Objects can then be created as instantiations of these class files. One JAVA object can call a method in another JAVA object. In recent years JAVA has become very popular, and is described in many books, for example “Exploring Java” by Niemeyer and Peck, O'Reilly & Associates, 1996, USA, and “The Java Virtual Machine Specification” by Lindholm and Yellin, Addison-Wedley, 1997, USA.

In JAVA, classes are loaded into the JVM's local memory at application runtime, typically in accordance with a ‘classpath’. The classpath defines a search order of locations (directories or JAR—JAVA archive—files) from which classes can be loaded, and a class located at a location earlier in the classpath is loaded before a class located at a location later in the classpath. Once loaded, a class is used from the JVM's local memory rather than reloading for each reference. A JVM can also execute with a shared class cache (i.e., a cache storing classes shared between the JVMs which persists beyond the lifetime of any JVM using it), in which case the classes are loaded into the shared class cache and shared between multiple JVMs. This reduces duplication of read-only data stored in local memory. Objects can then be created as instantiations of these class files. One JAVA object can call a method in another JAVA object. In recent years JAVA has become very popular, and is described in many books, for example “Exploring Java” by Niemeyer and Peck, O'Reilly & Associates, 1996, USA, and “The Java Virtual Machine Specification” by Lindholm and Yellin, Addison-Wedley, 1997, USA.

At runtime, classes can be added and amended to classpath locations which are directories. JAR files which have been opened at runtime cannot be modified as they are locked by classloaders. However, since the shared class cache persists beyond the lifetime of any JVM using it, modifications can be made to JAR files between JVM invocations which may make the class files in the updated JARs inconsistent with those in the cache. It is therefore possible that after an update, any number of classes in the cache have become out of date or “stale”. It is also possible for a cached class to be overridden by a new version of the class which is added to a different, earlier location in the classpath. In both these situations it is necessary for the runtime system to determine that a new version of the class exists and to mark the cached copy of the class as stale. This is difficult when the new version of the class has a different locations in the classpath to the cached class. One solution to this is to restrict new versions of classes from being added earlier in a classpath, but this limitation may not be acceptable for applications developers and maintainers as it may prevent maintenance or upgrade at runtime.

From U.S. Pat. No. 6,851,111 there is known a computer system including multiple class loaders for loading program class files into the system. A constraint checking mechanism is provided wherein a first class file loaded by a first class loader makes a symbolic reference to a second class file loaded by a second class loader, the symbolic reference including a description of a third class file. However, this known computer system does not address the problem of identifying those classes which are ‘stale’, and does not allow for dynamic updates.

In summary therefore, these known approaches have the disadvantage of not efficiently (given a cache with thousands of classes, efficiency in this regard is important) identifying those classes which should be marked ‘stale’ by a filesystem update, and do not support dynamic updates.

A need therefore exists for a shared classes cache computer system and method therefor wherein the above mentioned disadvantage(s) may be alleviated.

### SUMMARY OF THE INVENTION

In accordance with a first aspect of the present invention there is provided a shared classes cache computer system as claimed in claim 1.

In accordance with a second aspect of the present invention there is provided a method for operating a shared classes cache computer system as claimed in claim 10.

### BRIEF DESCRIPTION OF THE DRAWING(S)

One shared classes cache computer system and method therefor allowing efficient dynamic updates and incorporating the present invention will now be described, by way of example only, with reference to the accompanying drawing(s), in which:

FIG. 1 shows a block-schematic diagram illustrating a multiple JVM system incorporating a shared classes cache; and

FIG. 2 shows a block diagram illustrating a method for efficient dynamic updates in a JAVA shared classes cache used in the system of FIG. 1.

### DESCRIPTION OF PREFERRED EMBODIMENT(S)

As is known, where one or more JVMs are co-operatively using a single area of persistent shared memory (or cache) in which to find and store JAVA classes, normally each JVM finds its classes in class files on the filesystem, stored in JAR (JAVA Archive) files, ‘ZIP’ files or simply as class files in a directory. When using the shared cache, the JVMs will look first for classes in the cache and if they are not found, they are loaded from disk and then added to the cache. The cache persists beyond the lifetime of any JVM and must be removed explicitly. The benefits of such a system are increased data sharing (thus reduced footprint) and faster class loading due to loading from memory, rather than from disk.

Classes are loaded by classloaders, which have classpaths which they use to search for classes. A classloader searches left to right down a classpath, trying to find the class in each location until it is found. When a class is stored in the shared cache, it must be stored with a reference to the classpath belonging to the classloader that loaded it and an index into that classpath which indicates the exact path where the class was found. Thus, when a classloader tries to find a class in the cache, its classpath must “match” the classpath of any found class, such that the found class is the same class that would have been found on the file system using that classpath.

Since the shared cache is persistent beyond the lifetime of a JVM and since the data in it is immutable, any updates which occur on the file system must be reflected in the cache. Furthermore, given the nature of classpaths, an update occurring to a single classpath entry could replace/invalidate classes found in entries to the right of it. For example:

Given classpath “A; B; C; D”, imagine that a class X has been loaded into the cache from classpath entry C (index 2)—this means by implication that X was not found in entry A or B.

Suppose that C is updated with a new version of X and a classloader attempts to find class X in the shared cache using classpath “A; B; C; D”. The cache must not return this old version of C—instead, it should be marked “stale” and the new version should be loaded from disk and stored in the cache. Suppose then that B is updated on the file system and now contains a different version of X. The consequence is that for this classpath, the version stored in C is “masked”, because the version stored in B will always be found first (searching left to right). Therefore, when another classloader attempts to find class X in the shared cache, using classpath “A; B; C; D” after B has been updated, the cache must not return the version of X it already has which was found in C—that class is now stale too. Furthermore, any class which was stored in the cache from C or D could now be invalid as there could be a new version in B, so the cache should pessimistically tag all of these classes as “stale”.

In fact, for ALL classpaths containing B which are known to the cache, any class loaded from any classpath entry to the right of B should be marked as stale. For example, for classpath “B; E; J”, all classes loaded from E and J should also be marked stale.

This pessimistic stale marking must be done for two reasons: Firstly because the cache does not know the contents of a classpath entry or the delta of specific changes. Secondly because when a classloader requests a class from the cache, it passes its entire classpath and delegates responsibility of finding the class to the cache in a single request. If the design were such that the classloader made a request for each individual classpath entry before checking on disk, the stale marking would not have to be so pessimistic, but this would be a much less efficient method of loading classes.

The problem with this is: given a cache with thousands of classes—how to efficiently identify those classes which should be marked stale by a file system update? Known systems such as the Class Data Sharing (CDs) system of Sun Microsystems, Inc. (which is based on a read-only file which contains all system classes and cannot be updated) and the “Shiraz” system of IBM, Inc. do not support dynamic updates in this way.

As will be explained in greater detail hereafter, at least in its preferred embodiment, the present invention includes additional information along with a cached class in the cache. The additional information for each class is a reference to the classpath used to load the class, and an index into the classpath of the classpath entry from which the class was loaded. Additionally, each classpath used to store classes in the cache has a ‘stale from’ index, which is normally set to −1 to indicate that no entry in the classpath is stale. When a classpath entry then becomes stale, the “stale from” index can be updated and the stale classes can be easily identified.

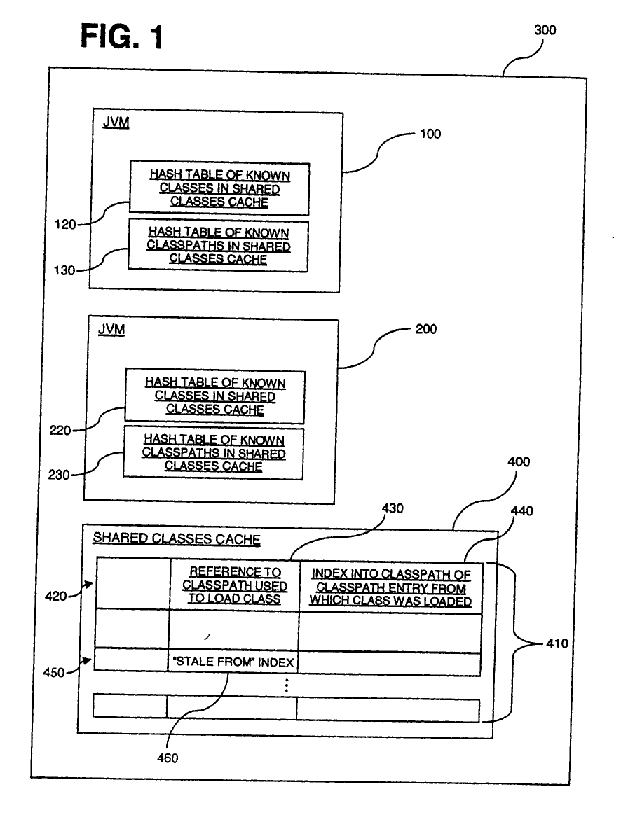

In the system of the preferred embodiment, a plurality of JVMs, of which only two, 100 and 200, are shown if FIG. 1, running on a computer system shown as 300. The computer system 300 incorporates a shared classes cache 400. Each JVM 100 or 200 maintains local hash tables of known or “identified” classes 120 or 220, and known or “identified” classpaths 130 or 230. These hash tables are populated with references to existing cache records when the JVM is initialized and are updated every time new entries are added to the cache.

As will be described in greater detail below, the shared classes cache 400 has an array 410 of serially written records, which are either class records or classpath records. A class record (such as record 420) contains a reference 430 to the classpath record and the classpath entry index 440 from which it was loaded. A classpath record (such as record 450) contains a “stale from” index 460. For each classpath record stored in the cache, the “stale from” index 460 is normally set to −1 to indicate that no entry in the classpath is stale. Many class records may be stored against the same classpath record. The cache is shared between JVMs.

Each JVM 100, 200 must maintain the local hash tables 120, 220, 130 and 230 of known classes and known classpaths in the cache. When an update is made to the cache, the local hash tables are updated.

An important feature of the preferred embodiment is how each local classpath hash table indexes classpaths in the shared cache:

Classpaths are indexed in terms of their individual classpath entries, e.g., classpath A; B; C; D will have four hash table entries, one for each classpath entry.

The hash table key is the string name of the classpath entry and the value is a circular linked list, each entry of which represents a classpath in the cache which contains the given classpath entry. Each item in the linked list contains:
A pointer to the classpath in the cache
The index of that classpath entry in the classpath
A pointer to the next item in the list (or itself if only one item)

For example, imagine that the following classpaths are added to the cache:
“A; B; C”
“A; B; C; D”
“D; C; B; A”
“E; F; B”
“G”

There will be seven entries in the hash table, one each for A, B, C, D, E, F and G:
“A” will contain a linked list of there items:
   Item 1 will point to “A; B; C” and will have index 0 (the position or the classpath entry “A” in the classpath “A; B; C”).
   Item 2 will point to “A; B; C; D” and will have index 0 (the position of the classpath entry “A” in the classpath “A; B; C; D”).
   Item 3 will point to “D; C; B; A” and have index 3 (the position of the classpath entry “A” in the classpath “D; C; B; A”).
“B” will contain a linked list of four items.
   Item 1 will point to “A; B: C” with index 1 (the position of the classpath entry “B” in the classpath “A; B; C”).
   Item 2 will point to “A; B; C; D” with index 1 (the position of the classpath entry “B” in the classpath “A; B; C; D”).
   Item 3 will point to “D; C; B; A” with index 2 (the position of the classpath entry “B” in the classpath “D; C; B; A”).
   Item 4 will point to “E; F; B” with index 2 (the position of the classpath entry “B” in the classpath “E; F; B”).
And so on . . .

The advantage of indexing in this way is that by doing a hash table lookup of a classpath entry, walking the linked list provides instant access to each classpath which contains that entry—there is no need to do any further searching or string comparison.

To identify the classes which have become stale following an update, imagining that B has been updated in the above example, the following procedure is used:

Firstly, find B in the classpath hash table.

Secondly, for each classpath in the linked list for B, change the “stale from index” value of the classpath in the cache from −1 to the index value in the linked list item:

So, “A; B; C” will be stale from 1 “A; B; C; D” will be stale from 1, “D; C; B; A” will be stale from 2 and “E; F; B” will be stale from 2. “G” is obviously not affected.

Thirdly, now that the appropriate classpaths in the cache have been modified, walk every non-stale class in the cache. For each class, compare the “classpath entry index” of the class to the “stale from index” in its classpath. If the “stale from index” is not −1 and the “classpath entry index” is greater than or equal to the “stale from index”, the class is stale and is tagged to indicate this.

This mechanism of identifying and marking stale classes is extremely efficient. It involves a single hash table lookup, then simply comparing and setting integer values. In the worst case scenario, the number of integer comparisons will be the sum of the total number of classes in the cache and the total number of classpaths.

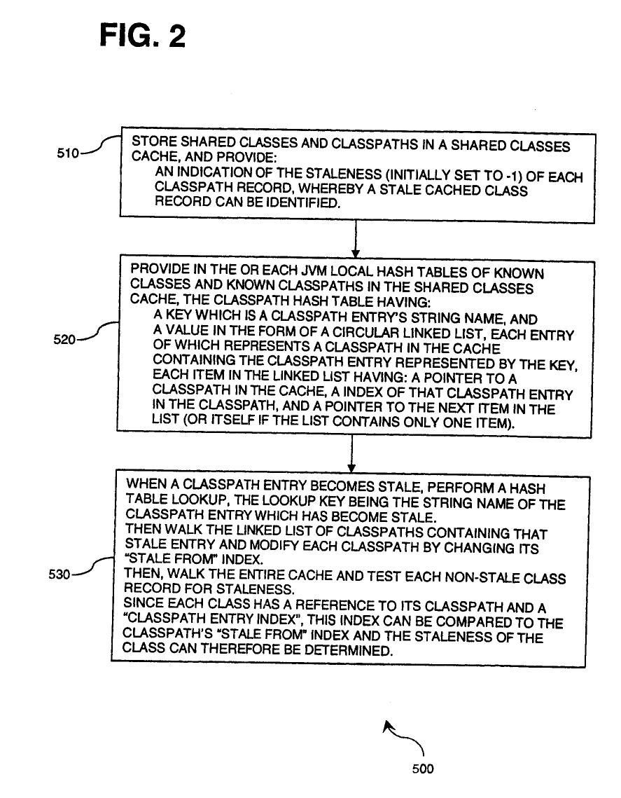

Referring now to FIG. 2, the method 500 used for dynamic updates in the JVM using shared classes system of FIG. 1 is as follows:

At step 510, shared classes are stored in a shared classes cache, which has:

class records and classpath records (the classpath records are referred to by the class records); and

an indication of the staleness (initially set to −1) of each classpath record, whereby a stale cached class record can be identified.

At step 520, in the or each JVM local hash tables of known classes and known classpaths in the shared classes cache are provided, the classpath hash table having:

a key which is a classpath entry's string name, and

a value in the form of a circular linked list, each entry of which represents a classpath in the cache containing the classpath entry represented by the key, each item in the linked list having:

a pointer to a classpath in the cache,

a index of that classpath entry in the classpath, and

a pointer to the next item in the list (or itself if the list contains only one item).

at step 530, when a classpath entry becomes stale, a hash table lookup is performed, the lookup key being the string name of the classpath entry which has become stale. Then the linked list of classpaths containing that stale entry is walked and each classpath is modified by having its “stale from” index changed. Then, the entire cache is walked (each record in the cache has a “size” from which the location of the next record can be computed, allowing the cache records to be walked in sequence) and each non-stale class record is tested for staleness. Since each class has a reference to its classpath and a “classpath entry index”, this index can be compared to the classpath's “stale from index” and the staleness of the class can therefore be determined.

It will be appreciated that the scheme for efficient dynamic updates in a JAVA shared classes cache described above is carried out in software running on a processor in one or more computers, and that the software may be provided as a computer program element carried on any suitable data carrier (not shown) such as a magnetic or optical computer disc.

It will be understood that the mechanism for efficient dynamic updates in a JAVA shared classes cache described above provides an extremely efficient technique for marking shared cache classes as “stale”, allowing for dynamic updates.

1. A shared classes cache computer system, the system comprising:
a cache for storing shared classes;
class referencing means for referencing class entries in the cache; and
an indication of the staleness of a referenced entry, whereby a stale cached class can be identified.

2. The system of claim 1 further comprising classpath referencing means for referencing classpaths used to load classes into the cache.

3. The system of claim 2 wherein the classpath referencing means comprises at least one virtual machine having a local hash table of known classpaths in the shared classes cache.

4. The system of claim 3 wherein the hash table comprises:
a key comprising a classpath entry's string name, and
a value comprising a circular linked list, each entry of which represents a classpath in the cache containing the classpath entry represented by the key.

5. The system of claim 4 wherein each item in the linked list comprises:
a pointer to a classpath in the cache,
an index of that classpath entry in the classpath, and
a pointer to one of:
a next item in the list, and
itself if the list contains only one item.

6. The system of claim 2 wherein the indication of the staleness of a referenced entry comprises an integer, of which a predetermined value indicates that a referenced classpath is not stale.

7. The system of claim 2 further comprising:
lookup means for, when a classpath entry has become stale, looking up the stale classpath entry in the classpath referencing means to find all classpaths containing the stale entry;
modification means for modifying the indication of staleness of each found classpath;
determination means for determining staleness of a class entry by comparing the indications of staleness of the classpath from which the class was loaded with the index of the class in that classpath.

8. The system of claim 1 wherein the system comprises a JAVA system.

9. The system of claim 8 wherein the system comprises a JAVA Virtual Machine system.

10. A method of operating a shared classes cache computer system, the method comprising:
storing shared classes in a shared classes cache;
providing class referencing means for referencing class entries in the cache; and
providing an indication of the staleness of a referenced entry, whereby a stale cached class can be identified.

11. The method of claim 10 further comprising providing classpath referencing means for referencing classpaths used to load classes into the cache.

12. The method of claim 11 wherein the classpath referencing means comprises in at least one virtual machine a local hash table of known classpaths in the shared classes cache.

13. The method of claim 12 wherein the hash table comprises:
a key comprising a classpath entry's string name, and
a value comprising a circular linked list, each entry of which represents a classpath in the cache containing the classpath entry represented by the key.

14. The method of claim 13 wherein each item in the linked list comprises:
a pointer to a classpath in the cache,
a index of that classpath entry in the classpath, and
a pointer to one of:
a next item in the list, and
itself if the list contains only one item.

15. The method of claim 11 wherein the indication of the staleness of a referenced entry comprises an integer, of which a predetermined value indicates that a referenced classpath is not stale.

16. The method of claim 11 further comprising, when a classpath entry has become stale, marking a class as stale by:
looking up the stale classpath entry in the classpath referencing means to find all classpaths containing the stale entry;
modifying the indication of staleness of each found classpath;
determining staleness of a class entry by comparing the indication of staleness of the classpath from which the class was loaded with the index of the class in that classpath.

17. The method of claim 10 wherein the system comprises a JAVA system.

18. The method of claim 17 wherein the system comprises a JAVA Virtual Machine system.

19. A computer program element stored on a data carrier and comprising computer program means for instructing the computer to perform substantially the method of claim 10.
